(19) United States
(12) Patent Application Publication
(10) Pub. No.: US 2025/0381908 A1
(43) Pub. Date: Dec. 18, 2025

(54) Whip Assembly with Detachable Insert

(71) Applicant: MWHIPS, INC., Beaumont, CA (US)

(72) Inventor: Cameron Merle Murray, Beaumont, CA (US)

(73) Assignee: MWHIPS, INC., Beaumont, CA (US)

(21) Appl. No.: 19/237,298

(22) Filed: Jun. 13, 2025

Related U.S. Application Data
(60) Provisional application No. 63/660,513, filed on Jun. 15, 2024.

(51) Int. Cl. B60Q 1/26; B60R 13/00; B62J 50/25

(52) U.S. Cl. CPC B60Q 1/2696; B60Q 1/2615; B60R 13/00; B62J 50/25

(57) ABSTRACT

A whip assembly designed for an off-road vehicle includes an insert, a base, and a mount. The insert includes an integrated illumination element designed to be detachably connected to the base. The base is characterized by a cylindrical shaft that includes a first cavity, at the upper end, designed to house the insert. A screw is inserted from the lower end of the shaft through a second cavity, passing into a third cavity, and engaging with a threaded hole in the insert, securely fastening the insert within the base. The detachable insert allows users to remove and replace only the detachable insert, while reusing the base and the mount.

### RELATED APPLICATIONS

This application claims priority to U.S. Provisional Patent Application 63/660,513, filed Jun. 16, 2024, entitled “Detachable Illumination Insert for Whip Assembly.”

### BACKGROUND

Safety flags and LED whip masts are commonly utilized on off-road vehicles to alert fellow drivers of their presence. Many off-road terrains mandate the use of whip masts to ensure other drivers are aware, reducing the risk of accidents. Typically measuring two to ten feet in length, these masts are affixed to the vehicle and equipped with an array of light emitting diodes (LEDs) or flags. These LEDs whips are powered by electrical energy sourced from either the off-road vehicle itself or a dedicated battery, serving to indicate the vehicle's presence.

The whips are prone to breaking, as whips extends above the vehicle to ensure visibility, making them vulnerable to shearing forces when passing under off-road terrains. These forces often result in whip breakage, requiring replacement to continue off-roading activities.

Conventional whips assemblies are available as a single unit, as the conventional whip assemblies typically consist of a base section for attachment to the vehicle and an integrated LED section for illumination purposes. One significant problem with these conventional assemblies is the need for whole unit replacement when the LED section fails or breaks. This is primarily due to the integration of the base and LED section into a single unit. As a result, if the LED section requires replacement due to damage, wear, or technological upgrades, the entire assembly, including the base, needs to be replaced. Similarly, conventional whip assemblies with an integrated rod and flag require the replacement of the entire unit when the flag section breaks.

This approach presents several disadvantages. Firstly, it leads to increased costs since replacing the entire assembly, including the functional base, is unnecessary when only the LED or flag section needs replacement. Secondly, it results in wastage of resources as functional components such as the base are discarded along with the LED or flag section, exacerbating environmental concerns and economic inefficiencies.

### SUMMARY

A whip assembly includes a base component having a first cavity and a second cavity in communication with the first cavity; a mount configured to be received in and detachable from the second cavity, the mount having a threaded portion to attach the mount to a structure external to the whip assembly; an insert configured to be received in and detachable from the first cavity, the insert having an upper section and a lower, internally-threaded section; and a bar configured to be received in the upper section of the insert.

The base component further includes a third cavity interposed between the first cavity and the second cavity, the third cavity in through communication with the first cavity and the second cavity along a longitudinal axis of the base, the third cavity having an upper cylindrical section and a lower conical section, the cylindrical section and the conical section configured to accommodate a threaded attachment device. The lower, internally-threaded cylindrical section is configured to receive the threaded attachment device, and the threaded attachment device is configured to engage the internally threaded section to securely couple the insert in the first cavity of the base component. The base component also includes a first through hole formed in the second cavity orthogonal to the longitudinal axis. The mount includes a second through hole formed to align with the first through hole with the mount received in the second cavity. The whip assembly further includes a locking pin and a corresponding keeper, the locking pin configured to fit an aligned first through hole and second through hole to securely couple the mount to the base, the keeper configured to prevent retraction of the locking pin from the aligned first through hole and second through hole. Still further, the base includes an internal, polygon-shaped head section formed at an upper extremity of the first cavity. The insert comprises a top section formed as a polygon and configured to be received in the internal, polygon-shaped head section of the base.

In an aspect, the bar is configured to be permanently attached in the upper section of the insert by gluing, welding, or press fitting. In another aspect, the bar includes an array of light emitting diodes (LEDs) formed on an outer surface of a portion of the bar; and an internal, integrally-formed wiring system to provide electrical power to the LEDs, the wiring system comprising a connector for coupling to an external source of electrical power. In another aspect, the bar is configured with a flag bracket for attaching a flag to the bar

### DESCRIPTION OF THE DRAWINGS

The detailed description refers to the following figures in which like numerals refer to like items, and in which:

FIG. 1 is a perspective view of an example whip assembly according to the present disclosure;

FIG. 2 is an exploded perspective view of the whip assembly of the FIG. 1, according to the present disclosure;

FIG. 3 is a cross-sectional view of the base of the whip assembly, along line A-A′ of the FIG. 2;

FIG. 4 is a cross-sectional view of the mount of the whip assembly, along line A-A′ of the FIG. 2;

FIG. 5 is a cross-sectional view of the insert of the whip assembly, along line A-A′ of the FIG. 2;

FIGS. 6A and 6B illustrate an example insert with an integrated elongated LED bar;

FIG. 7 illustrates an example insert with an integrated bar with a flag on top;

FIG. 8 illustrates an example lock pin and keeper configured to secure components of the whip assembly of FIG. 1;

FIG. 9 illustrates an example electrical harness for use with the whip assembly and associated bar configured with an array of LEDs shown in FIG. 6A; and

FIG. 10 illustrates an example whip assembly with an integrated camera bar.

### DETAILED DESCRIPTION

Examples described in the present disclosure are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

As used herein, the term ‘exemplary’ or ‘illustrative’ means ‘serving as an example, instance, or illustration.’ Any implementation described herein as exemplary or illustrative is not necessarily to be construed as advantageous and/or preferred over other embodiments. Unless the context requires otherwise, throughout the description and the claims, the word ‘comprise’ and variations thereof, such as ‘comprises’ and ‘comprising’ are to be construed in an open, inclusive sense, i.e., as ‘including, but not limited to.’

The present disclosure provides a whip assembly for use on an off-road, marine, or other recreational vehicle. The whip assembly addresses deficiencies in current mast assemblies by providing a detachable illumination (e.g., LED) section, a flag section, or other component section while retaining a reusable base, thereby reducing costs, minimizing resource wastage, and enhancing overall efficiency. The whip assembly consists of three major components, an insert, a base, and a mount. The base is configured to be detachable from the mount of the whip assembly, allowing for the easy removal and attachment of the elongated portion of the whip assembly, which includes the base and insert, when not in use from an off-road vehicle. Further, the disclosed whip assembly features the detachable insert with an integrated the illumination component, such as an array of Light Emitting Diodes (LEDs). The detachable insert is configured to be detached from the base of the whip assembly. This allows a user to remove and replace the illumination insert from the off-road vehicles, when required. In some embodiments, the detachable insert can be integrated into a rod with a flag on top.

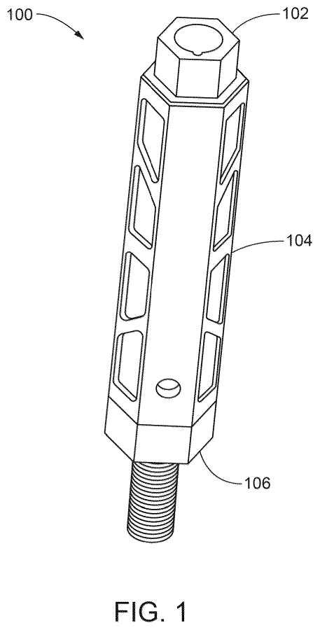

Referring to FIG. 1, a perspective view of a whip assembly 100 according to the present disclosure is illustrated. The whip assembly 100 is configured to be attached to a panel of an off-road vehicle using, for example, but not limited to, a whip tab or cage bracket. The whip assembly 100 includes an insert 102, a base 104, and a mount 106. The base 104 forms a close fit with the insert 102 and the mount 106, as shown in the FIG. 1. The mount 106 is configured to be securely attached to the panel of an off-road vehicle using, for example, but not limited to, a whip tab or cage bracket. The insert 102 is configured to securely hold the flag or the array of LEDs for illumination purpose.

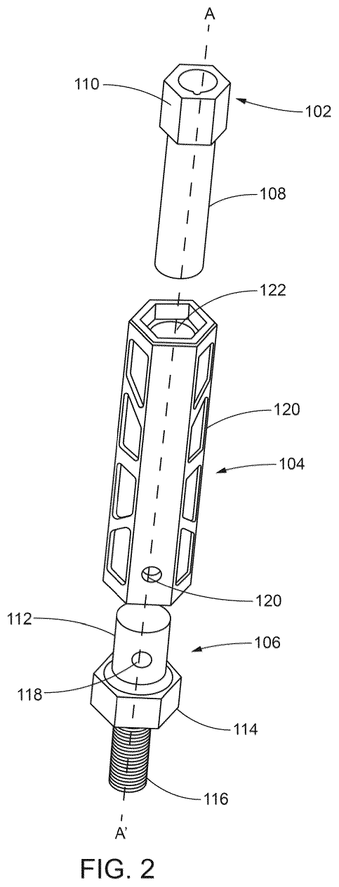

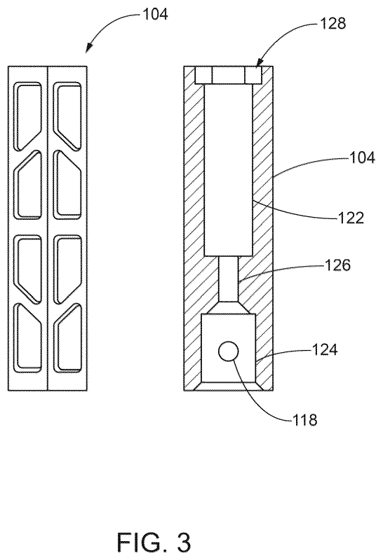

FIG. 2 is an exploded perspective view of the whip assembly 100 of FIG. 1, according to the present disclosure. The exploded perspective view of the whip assembly 100 comprises the insert 102, base 104, and mount 106. As shown, the insert 102 is comprised of a shank portion 108 and a head portion 110. The diameter of the shank portion 108 is adapted to be matched with a cavity formed at the upper end of the base 104. The base 104 comprises a cylindrical shaft 120, with two i.e., first and second internal cavities (122, 124; see FIG. 3) formed at both, i.e., upper and lower ends respectively. The diameter of the first cavity 122 is adapted to accommodate the shank portion 108 snugly, ensuring a secure interconnection between them. Further, the second cavity 124 formed at the lower end of the shaft 120 is adapted to partially receive the mount 106. The mount 106 includes a coupling portion 112 and a threaded portion 116, wherein the threaded portion 116 terminates at the junction with the coupling portion 112 in a hexagonal-shaped portion 114. The diameter of the coupling portion 112 is adapted to be fit inside the second cavity 124 of the cylindrical shaft 120 of the base 104, to form a secure interconnection between them.

FIG. 3 illustrates a cross-sectional view of the base 104 of the whip assembly 100, along line A-A′ of FIG. 2. As shown, the first cavity 122 is formed internally in the shaft 120 at the upper portion of the base 104, which is interconnected to the second cavity 124 formed internally in the shaft 120 at the lower portion of the base 104, via a third cavity 126. The diameter of the first cavity 122 is adapted to be matched with the diameter of the shank portion 108 of the insert 102, to ensure a secure connection between them. A head retaining cavity 128 at the opening of the first cavity 122 is configured to receive the insert 102, comprises a shape (e.g., hexagonal) which is adapted to receive the head portion 110. For instance, as shown in FIGS. 2 and 3, the insert 102 has a circular shank portion 108 and a hexagon shaped head portion 110. Now, to receive the insert 102, the head retaining cavity 128 and the cavity 122, are designed to comprise hexagonal and circular shapes respectively, to accommodate the circular shank portion 108 and the hexagon shaped head portion 110. In some non-limiting examples, the shank portion 108 may have various shapes, such as circular, square, rectangular, or any other suitable shape. Similarly, the head portion 110 may have shapes including but not limited to a hexagon, octagon, or any other polygonal shape. Similarly, to accommodate inserts with different shank and head shapes, the head retaining cavity 128 and the first cavity 122 of the base 104 are designed to have complementary shapes, to provide a secure interconnection between the inserts and the base, during the operation of the whip assembly 100.

By way of example, but not limitation, the base 104 is formed of a rigid material to ensure stability and durability. Such materials may include, but are not limited to, fiberglass, stainless steel, plastic, aluminum, high-grade aluminum, or any other suitable rigid material. This choice of material enhances the overall strength and resilience of the whip assembly.

In an example, the shaft 120 is designed with a hexagonal external shape. This geometric configuration is specifically chosen to enhance the grip during the processes of mounting or detaching the base 104, to the insert 102 or the mount 106. The hexagonal shape provides multiple flat surfaces for a tool or hand to hold, reducing the likelihood of slippage during assembly or disassembly. Additionally, the external surface of the shaft 120 features textured patches or impressions. These textured areas increase the friction between the user's hand and the shaft, further preventing slippage during handling and manipulation of the assembly. It should be noted that while a hexagonal shape is preferred in this embodiment, the design of the shaft 120 is not limited to this configuration. In other embodiments, the shaft 120 may adopt various other shapes, such as polygonal, circular, rectangular, or other suitable geometries, depending on the specific user preference. These alternative shapes, like the hexagonal configuration, are chosen to facilitate ease of handling and manipulation during the assembly and disassembly processes.

Further, as shown in FIG. 3, the second cavity 124 of the base 104 is configured to partially accommodate the mount 104. The diameter of the second cavity 124 is adapted to accommodate the coupling portion 112 of the mount 106, to ensure a secure connection between them. The shaft 120 comprises a through first hole 118 extending orthogonal to the longitudinal axis A-A′, through the second cavity 124. Furthermore, the third cavity 126 comprises a diameter smaller than that of the first and second cavities (122, 124), to at least facilitate the passage of a screw therethrough. Further, the interface between the third cavity 126 and the second cavity 124 is contoured to provide accommodation for the screw's head, ensuring proper alignment and secure engagement.

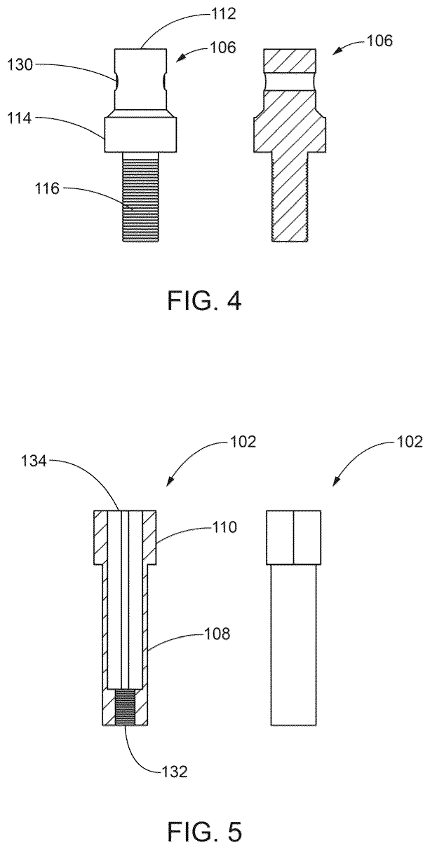

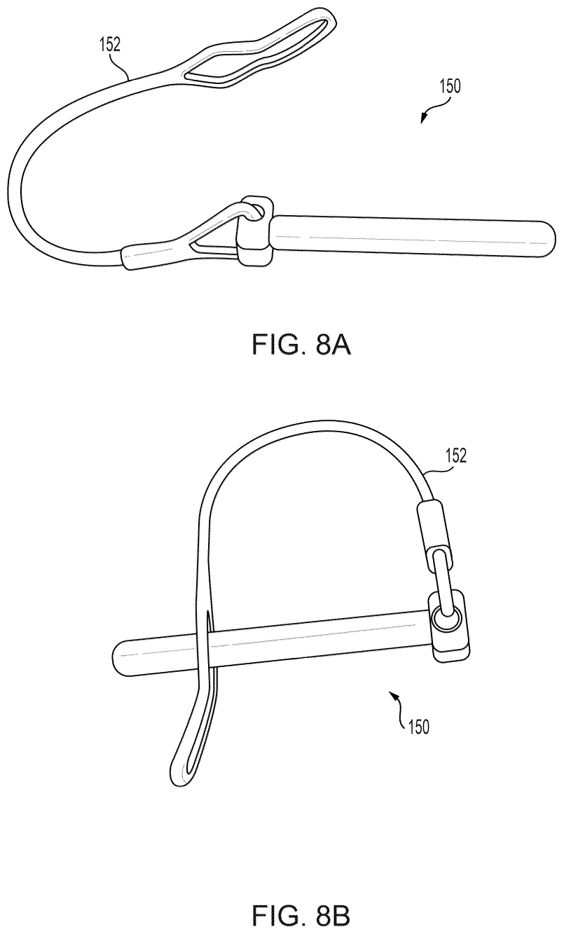

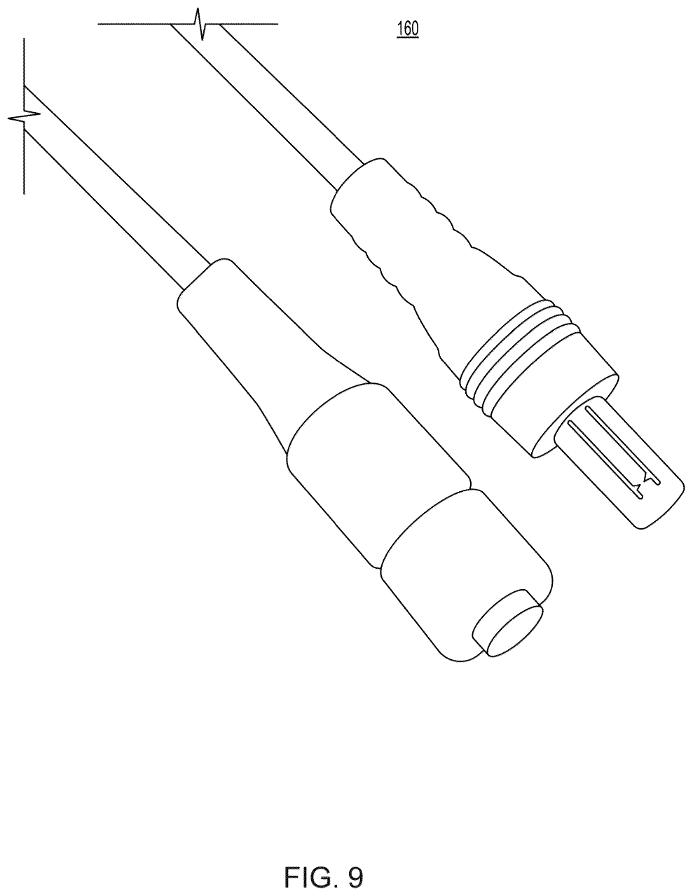

FIG. 4 is a cross-sectional view of the mount 106 of the whip assembly 100 along line A-A, of the FIG. 2. The mount 106 is comprised of the coupling portion 112, the nut shaped portion 114, and the threaded portion 116. Further, the mount 106 is comprised of a second through hole 130 extending orthogonal to the longitudinal axis A-A′, through the coupling portion 112. The location of the first hole 118 within the base 104 and the second hole 130 within the mount 106 are predetermined such that the first hole 118 and the second hole 130 align precisely to coincide with each other, when the mount 106 is securely positioned within the base 104, as shown in FIG. 1. By way of example, but not limitation, a lock pin (see FIG. 8) may be used to be engaged with the first and second holes 118, 130 in the coinciding positions when the mount 106 is securely positioned within the base 104, as shown in FIG. 1. By way of example, but not limitation, any other suitable lock mechanism such as a bolt, latch, or fastener may be utilized.

The mount 106 is utilized to mount the whip assembly 100 to a panel of a vehicle such as an off-road vehicle. For example, the mount 106 threaded portion 116 passes through the vehicle's panel to secure the mount 106 by using any suitable means e.g., a nut. By way of example, but not limitation, a washer and/or lock washer may be interposed between the threaded portion 116 and the vehicle's panel to strengthen the attachment between them. In some embodiments, the whip assembly 100 is configured to be securely attached to a panel of an off-road vehicle using, for example, but not limited to, a whip tab or cage bracket (not shown).

The arrangement of the holes (118, 130) of the base 104 and the mount 106 of whip assembly 100 allow the user to easily lock and unlock the base 104 from the mount 106, and to let the user to detach and replace the base 104 of the whip assembly 100. By way of example, but not limitation, the base 104 may be easily removed from the mount 106 after disengaging lock pin 150 (see FIG. 8) from the aligned first and second holes 118, 130.

FIG. 5 illustrates a cross-sectional view of the insert 102 of the whip assembly 100 along line A-A′, of FIG. 2. As shown, the insert 102 is includes shank portion 108 and head portion 110. Further, the insert 102 is comprised of an internal thorough hole that is comprised of a threaded hole 132 and a hollow portion 134, formed internally between the shank portion 108 and the head portion 110. The threaded hole 132 comprises threads to accommodate any screw or bolt. Further, the hollow portion 134 may comprise one of any suitable shapes such as circular, hexagon, polygon and like as non-limiting examples.

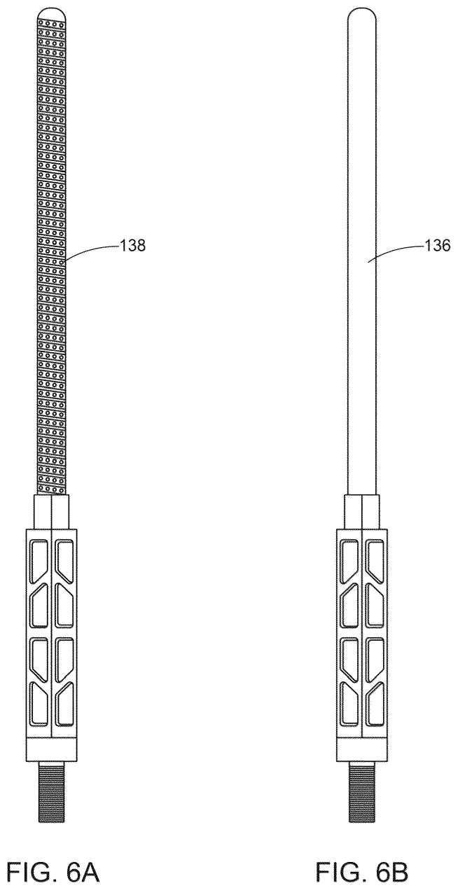

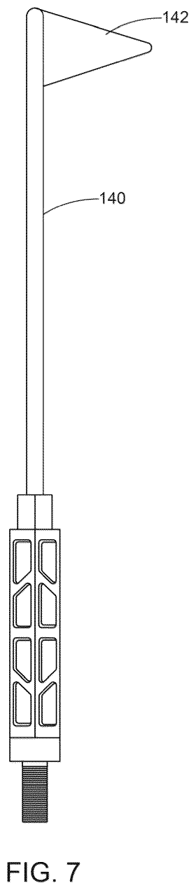

Further, the hollow portion 134 is configured to accommodate a bar of different lengths on which an array of LEDs (LED array-equipped bar 138) may be attached in any suitable manner, as shown in FIG. 6A. FIG. 6B illustrates non-illumination equipped bar 136, which may be further configured to support other components and devices such as cameras. In some examples, the hollow portion 134 and the bars 136 and 138 are formed together as a single element at the time of manufacture, or permanently attached together, e.g., by means of glue, welding, and press fitting techniques. In some embodiments, the hollow portion 134 is configured to accommodate a bar 140 of different lengths on which a flag 142 may be attached in any suitable manner, as shown in FIG. 7. Further, the hollow portion 134 and the bar 140 may be formed together as a single element at the time of manufacture, or permanently attached together, e.g., by means of glue, welding, and press fitting techniques. Furthermore, the bar 140 may be provided with different cross-sectional shapes including cylindrical or polygonal, and may be tapered or of an essentially constant cross-section.

To provide electrical power to the LEDs of the LED array, the bar 138, which supports the LEDs, may have an internal wiring harness (not shown) formed integrally with the bar 138 and having a distal end such that the internal wiring harness connects to the LEDs and, at its distal end, is configured to connect to an external power supply such as the vehicle's battery.

By way of example, but not limitation, the insert 102 and the bar 136 are formed of a lightweight, flexible material. Materials such as silicone, fiberglass, polyethylene, or thermoplastic elastomers (TPE) may be employed, as non-limiting examples. As noted above, in some examples, the bar 138 may be formed with an internal wiring harness to connect vehicle or other electrical power sources to illumination components or other electrical components supported by the bar 138.

With reference to FIGS. 3 and 5, further, to secure the insert 102 within the base 104, a screw of appropriate dimensions is utilized. The process begins with the placement of the insert 102 into the first cavity 122 of the shaft 120. This is done by introducing the shank portion 108 into the first cavity 122, proceeding until the head portion 110 of the insert 102 is securely fitted into the head retaining cavity 128 of the base 104. To ensure a secure connection between the components, a screw is introduced from the second cavity 124 of the shaft 120. The screw or other fastening device is inserted in such a manner that its threads engage with the threaded hole 132 of the insert 102, thereby firmly securing the insert 102 within the base 104.

Further, to assemble the mount 106 with the base 104, the second cavity 124 of the shaft 120 is aligned to receive the coupling portion 112 of the mount 106. The alignment process involves positioning both the base 104 and the mount 106 in such a way that the first hole 118 of the base 104 and the second hole 130 of the mount 106 coincide with each other. Once the holes 118, 130 are aligned, a lock pin can be introduced through the coinciding holes. This lock pin serves to secure the connection between the mount 106 and the base 104, ensuring stability and maintaining the integrity of the assembly. The insertion of the lock pin provides a secure fastening that helps to prevent unintentional disassembly or movement between the mount 106 and the base 104 during operation.

FIG. 8 illustrates an example lock pin 150 that may be positioned through the aligned first hole 118 of the base 104 and the second hole 130 of the mount 106. The lock pin 150 may be configured with a keeper 152 that prevents unwanted/unintentional removal of the lock pin 150.

FIG. 9 illustrates an electrical connection device 160 that is configured to electrically couple the internal electrical wiring harness of LED array-equipped bar 138 of FIG. 6A to a vehicle's power source (e.g., battery, alternator) or to an alternative power supply. The electrical connection device 160 may be configured with a switch (not shown), which in an example, may be a rocker switch. The electrical connection device 160 may attach mechanically to a bar configured with the LED array or other electrical components using any suitable attachment mechanism. Other configurations of electrical connection devices may be appropriate for other arrays of LEDs.

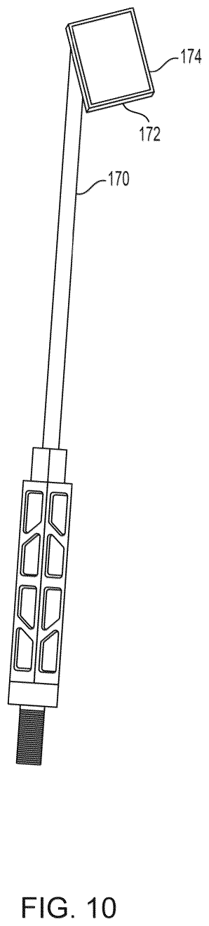

FIG. 10 illustrates bar 170 that is configured with bracket 172 to support and securely hold, at its top end, a camera 174 that may be operated by power suppled through the bar 170, or that may rely on batteries within the camera 174 for electrical power. The bar 170 is configured at its lower end to fit within hollow portion 134 of insert 102. In an aspect, the bar 170 includes, at its upper end, a threaded fitting and corresponding threaded cap (not shown). The threaded cap may be removed and the bracket 172 may be securely affixed to the threaded fitting. Other mechanisms may be employed to securely affix the bracket 172 to the bar 170. In another aspect, the bar 170 may be provided with the bracket 172 already affixed. In yet another aspect, the bar 170 may be supplied with a set of interchangeable brackets in order to accommodate different devices.

With reference to the FIGS. 1-10, the present disclosure provides a whip assembly 100 for use on an off-road vehicle, with a detachable insert 102 that holds an illumination bar such the LED array-equipped bar 138. The detachable insert 102 is configured to be detachable from the base 104 of the whip assembly 100. This allows the user to remove as well as replace the detachable insert 102 and LED array-equipped bar 138 from the off-road vehicles, when required e.g., due to damage, wear, or technological upgrades. Thus, this would eliminate the need for whole unit replacement when only the LED array-equipped bar 138 fails or breaks. Further, the present disclosure results in decreased costs since replacement of the insert only, when only the LED array-equipped bar 138 needs replacement, saves a cost of a new base, which contributes a substantial cost to the whip assembly 100. Further, the base 104 also is configured to be detachable from the mount 106 of the whip assembly 100, allowing for the easy removal and attachment of an elongated portion of the whip assembly 100, which includes the base 104 and insert 102, when not in use with the off-road vehicle. Similarly, the whip assembly 100, with the detachable insert 102 that holds the rod 140 with the flag 142, or the bar 170 allows the user to remove as well as replace the detachable insert 102 from the off-road vehicles, when required e.g., due to damage, wear, or aesthetic upgrades. Thus, this would eliminate the need for whole unit replacement when only the flag section breaks or the camera section breaks.

Further, the whip assembly 100 also offers the user the ability to customize or accessorize the assembly 100. This is achieved by providing the option to use different inserts 102 that vary in size, color, or features with the same base. This flexibility allows users to tailor the whip assembly 100 to their specific needs or preferences. For example, users could choose an insert with a different color to match the aesthetic of their off-road vehicle, or they could select an insert of a different size to adjust the intensity or spread of the illumination. This feature enhances the versatility of the whip assembly 100, making it adaptable to a wide range of user requirements and applications.

Finally, while the present disclosure has been described above with reference to various exemplary embodiments, many changes, combinations, and modifications may be made to the exemplary embodiments without departing from the scope of the present disclosure. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present disclosure.

I claim:

1. A whip assembly, comprising:
a base component comprising a first cavity and a second cavity in communication with the first cavity;
a mount configured to be received in and detachable from the second cavity, the mount comprising a threaded portion to attach the mount to a structure external to the whip assembly;
an insert configured to be received in and detachable from the first cavity, the insert comprising an upper section and a lower, internally-threaded section; and
a bar configured to be received in the upper section of the insert.

2. The whip assembly of claim 1, wherein the base component further comprises a third cavity interposed between the first cavity and the second cavity, the third cavity in through communication with the first cavity and the second cavity along a longitudinal axis of the base, the third cavity comprising an upper cylindrical section and a lower conical section, the cylindrical section and the conical section configured to accommodate a threaded attachment device,
wherein the lower, internally-threaded section is configured to receive the threaded attachment device,
wherein the threaded attachment device is configured to engage the lower, internally threaded section to securely couple the insert in the first cavity of the base component.

3. The whip assembly of claim 2, wherein the base component comprises a first through hole formed in the second cavity orthogonal to the longitudinal axis,
wherein the mount comprises a second through hole formed to align with the first through hole with the mount received in the second cavity,
the whip assembly further comprising a locking pin and a corresponding keeper, the locking pin configured to fit an aligned first through hole and second through hole to securely couple the mount to the base, the keeper configured to prevent retraction of the locking pin from the aligned first through hole and second through hole.

4. The whip assembly of claim 1, wherein the base further comprises an internal, polygon-shaped section formed at an upper extremity of the first cavity,
wherein the insert comprises a head section formed as a polygon and configured to be received in the internal, polygon-shaped section of the base.

5. The whip assembly of claim 1, wherein the bar is configured to be permanently attached in the upper section of the insert.

6. The whip assembly of claim 5, wherein the bar is permanently attached to the insert by one of gluing, welding, and press fitting.

7. The whip assembly of claim 1, wherein the bar and the insert are formed as a single element.

8. The whip assembly of claim 1, wherein the bar comprises:
a plurality of light emitting diodes (LEDs) formed on an outer surface of a portion of the bar; and
an internal, integrally-formed wiring system to provide electrical power to the LEDs, the wiring system comprising a connector for coupling to an external source of electrical power.

9. The whip assembly of claim 1, wherein the bar comprises a flag bracket for attaching a flag to the bar.

10. The whip assembly of claim 1, wherein the upper section of the insert is cylindrical.

11. The whip assembly of claim 1, wherein the upper section of the insert is formed as a polygon.

12. A vertical whip assembly, comprising:
a base;
a mount configured to be detachably connected to and to penetrate a lower end of the base;
an insert configured to be detachably connected to and to penetrate an upper end of the base;
a vertical bar permanently connected in an upper end cavity of the insert;
a removable lock pin and keeper assembly to maintain the mount connected to the base; and
an removable internal attachment device configured to maintain the insert connected to the base.

13. The vertical whip assembly of claim 12, wherein the base is configured to prevent rotation of the insert in the base.

14. The vertical whip assembly of claim 12, wherein the vertical bar comprises:
an array of LEDs formed on an exterior of the bar;
an electrical conductor formed integrally with the vertical bar and configured to provide electrical power to LEDs in the array of LEDs;
a connector formed at a distal end of the electrical conductor and configured to couple the electrical conductor to an electrical power supply.

15. The vertical whip assembly of claim 12, wherein the mount is configured to detachably connect to a vehicle.

16. A whip assembly for an off-road vehicle comprising:
a detachable insert with an integrated illumination component;
a base with a first cavity to receive the insert; and
a mount configured to be secured to a vehicle, wherein the illumination component is an array of LEDs.

17. The whip assembly of claim 16, wherein the base comprises a cylindrical shaft with a first cavity configured to fit the insert, a second cavity configured to accommodate the mount, and a third cavity providing a passage for fastening means to secure the insert and the base.

18. The whip assembly of claim 17, wherein the insert comprises a shank portion and a head portion, the shank portion being received within the first cavity of the base, and the head portion being secured by a complementary-shaped head retaining cavity in the base.

19. The whip assembly of claim 18, wherein the shank portion and head portion of the insert are hexagonal in shape.

20. The whip assembly of claim 16, wherein the base comprises a through-hole extending orthogonal to a longitudinal axis of the cylindrical shaft for accommodating a locking mechanism.
